(19) United States
(12) Patent Application Publication
(10) Pub. No.: US 2013/0087221 A1
(43) Pub. Date: Apr. 11, 2013

(54) ADJUSTABLE POWER STEERING FLUID PUMP VALVE

(71) Applicant: Turn One, Inc., Saginaw, MI (US)

(72) Inventor: Jeffrey J. Roethlisberger, Saginaw, MI (US)

(73) Assignee: TURN ONE, INC., Saginaw, MI (US)

(21) Appl. No.: 13/646,226

(22) Filed: Oct. 5, 2012

Related U.S. Application Data
(60) Provisional application No. 61/544,823, filed on Oct. 7, 2011.

(51) Int. Cl. F16K 21/00

(52) U.S. Cl. 137/455

(57) ABSTRACT

A power steering fluid pump valve may include a body and a metering plunger. The body may have an inlet, an outlet, and a passage extending between the inlet and the outlet for power steering fluid-flow therethrough. The metering plunger may be partly or more located in the passage. In use, the metering plunger may be adjusted to different positions in the passage to change the volumetric flow rate of power steering fluid-flow through the body's outlet.

### REFERENCE TO CO-PENDING APPLICATION

This application claims the benefit of, and incorporates by reference in its entirety, U.S. Provisional Application Ser. No. 61/544,823, filed Oct. 7, 2011.

### TECHNICAL FIELD

The present disclosure relates generally to power steering fluid pumps, and more particularly to valves used in power steering fluid pumps.

### BACKGROUND

Automotive power steering systems typically include a number of components connecting a driver's steering wheel to steerable road wheels for controlling the direction of automobile travel. In general, power steering systems can increase mechanical advantage, translate rotary motion to linear motion, and provide power assist to the driver for turning the road wheels. Power steering fluid pumps are often equipped in the systems in order to provide pressurized power steering hydraulic fluid to other components of the systems through one or more hoses. In some cases, a valve is used with the pumps to regulate pressurized power steering fluid exiting the pumps.

### SUMMARY

A power steering fluid pump valve may include a body and a metering plunger. The body may have an inlet, an outlet, and a passage extending between the inlet and the outlet for power steering fluid-flow therethrough. The metering plunger may have a stem partly or more located in the passage. Adjustment of the metering plunger may bring the stem to different forward and rearward axial positions within the passage, and may change the volumetric flow rate of power steering fluid-flow exiting the outlet.

A power steering fluid pump valve may include a body, a metering plunger, and an adjustment feature. The body may have an inlet, an outlet, and a passage extending between said inlet and said outlet for power steering fluid-flow therethrough. The metering plunger may be located partly or more in the passage. The adjustment feature may releasably retain the metering plunger relative to the body in two or more positions. Each position may correspond to a different location of the metering plunger in the passage, and may correspond to a different volumetric flow rate of power steering fluid-flow exiting the outlet.

A power steering fluid pump valve may include a body, a metering plunger, multiple notches, a pin, and a spring. The body may have an inlet, an outlet, and a passage extending between the inlet and the outlet for power steering fluid-flow therethrough. The metering plunger may have a portion partly or more located in the passage. The notches may be located in the body, or may be located in the metering plunger. Each of the notches may correspond to a position of the portion within the passage, and may correspond to a volumetric flow rate of power steering fluid-flow exiting the outlet. The pin may extend from the other of the body or the metering plunger that does not have the notches. The pin may be constructed for insertion into one of the notches. The spring may bias together the pin and a notch in which the pin is inserted. In order to move the pin from one notch to another notch, the metering plunger may be moved against the bias of the spring, and, during this movement, may be moved circumferentially relative to the body, may be moved axially relative to the body, or may be moved both circumferentially and axially relative to the body.

### BRIEF DESCRIPTION OF THE DRAWINGS

The following detailed description of preferred embodiments and best mode will be set forth with reference to the accompanying drawings, in which:

FIG. 1 is a side view of a body of an embodiment of a power steering fluid pump valve;

FIG. 2 is a sectional view of the body taken at arrows 2-2 in FIG. 1;

FIG. 3 is an enlarged fragmentary view showing notches located in the body of FIG. 1;

FIG. 4 is a sectional view of the body taken at arrows 4-4 in FIG. 1;

FIG. 5 is a front view of a flange of the body of FIG. 1;

FIG. 6 is a side view of an embodiment of a metering plunger of the power steering fluid pump valve;

FIG. 7 is a side view of an embodiment of a knob of the power steering fluid pump valve;

FIG. 8 is a sectional view of the knob of FIG. 7;

FIG. 9 is a rear view of the knob of FIG. 7;

FIG. 10 is a side view of an embodiment of a calibration fitting of the power steering fluid pump valve;

FIG. 11 is a rear view of the calibration fitting of FIG. 10 taken at arrows 11-11;

FIG. 12 is a front view of the calibration fitting of FIG. 10;

FIG. 13 is a sectional view of the calibration fitting of FIG. 10;

FIG. 14 is a side view of an embodiment of a banjo of the power steering fluid pump valve;

FIG. 15 is a top view of the banjo of FIG. 14;

FIG. 16 is a sectional view of the banjo of FIG. 14; and

FIG. 17 is a perspective view of an embodiment of a spring of the power steering fluid pump valve.

### DETAILED DESCRIPTION OF PREFERRED EMBODIMENTS

Referring in more detail to the drawings, an embodiment of a power steering fluid pump valve 10 is equipped in a power steering fluid pump to regulate pressurized fluid-flow coming out of the pump. In particular, the valve 10 is inserted and sealed into a housing of the power steering fluid pump, and regulates the volumetric flow rate of fluid-flow exiting the pump and traveling to a hose or conduit and eventually traveling to a downstream component of the associated power steering system. The valve 10 is designed so that it can be manually adjusted by the user to change the volumetric flow rate of power steering fluid-flow exiting the valve and to the connected hose. The adjustability of the valve 10 can be useful in certain applications including for racing, such as in the National Association for Stock Car Auto Racing (NASCAR).

In NASCAR racing, for example, the valve 10 can be used as a pre-race testing device to select one of several non-adjustable power steering fluid pump valves that have a fixed and single volumetric flow rate for use during the actual race. In this instance, the valve 10 would be installed and a driver would take practice runs around a track, each run at a different adjusted volumetric flow rate value (e.g., 1.0 gallon per minute (GPM), 1.5 GPM, 2.0 GPM, etc.). Based on steering performance and feel during these runs, the driver would then be able to decide which non-adjustable power steering fluid pump valve with its fixed volumetric flow rate to install in the race car for the actual race. Of course, other applications are possible including applications in which the valve 10 is not used as a testing device and is instead used as the primary valve in the power steering fluid pump.

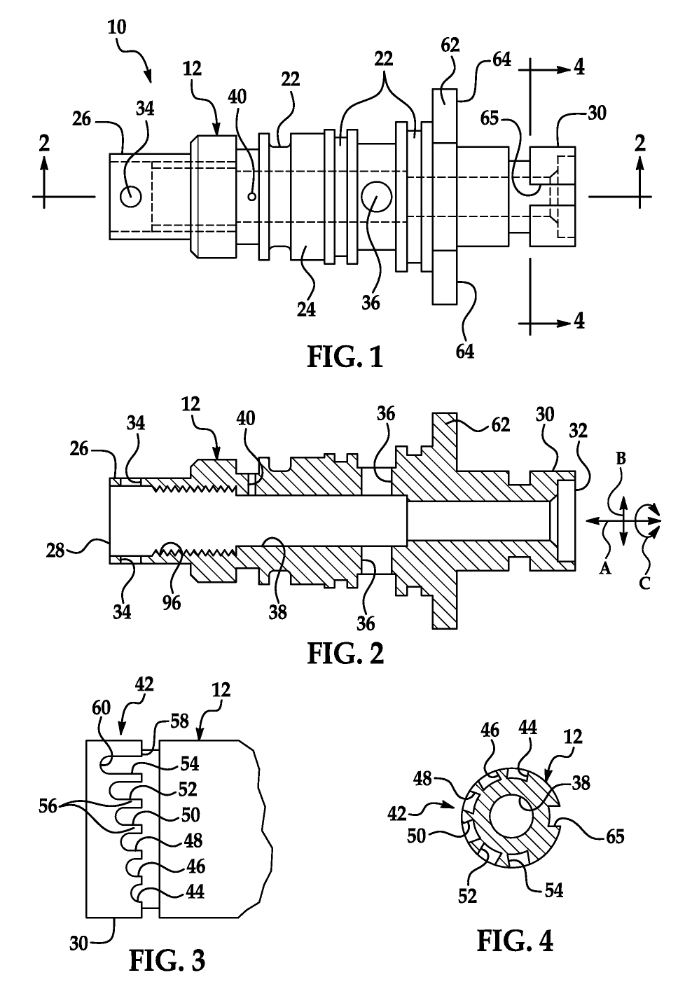

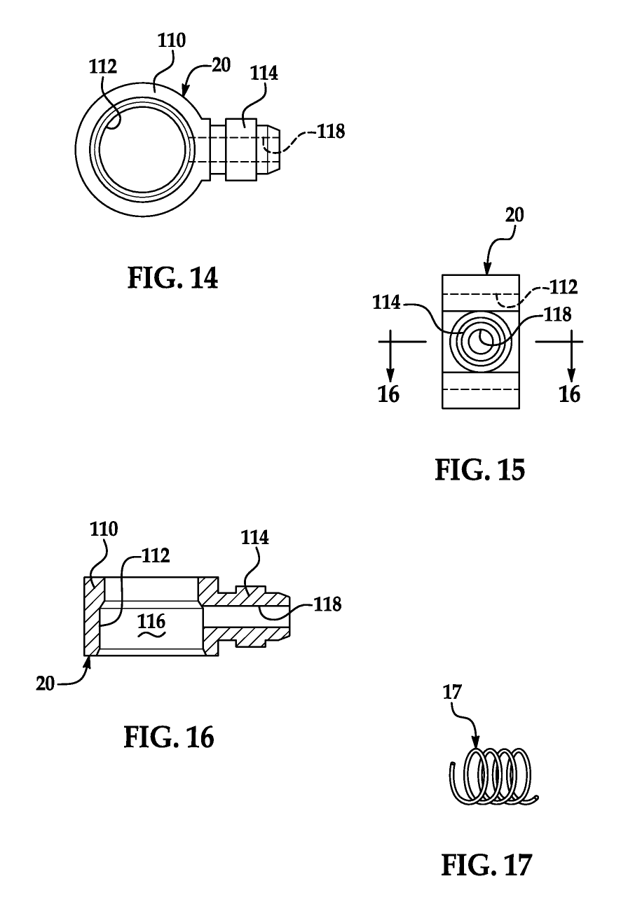

In the embodiment illustrated in FIGS. 1-17, the power steering fluid pump valve 10 may include a body 12 (FIGS. 1-5), a metering plunger 14 (FIG. 6), a knob 16 (FIGS. 7-9), a spring 17 (FIG. 17), a calibration fitting 18 (FIGS. 10-13), and a banjo 20 (FIGS. 14-16). Referring in particular to FIGS. 1 and 2, the body 12 serves as the main structural component of the valve 10 through which power steering fluid flows from the pump and to downstream components. The body 12 can have different designs and constructions depending in part upon the application, the power steering fluid pump, and other components of the power steering system. In this embodiment, the body 12 is made out of a 7075 aluminum alloy material, but other materials such as other metals or composites are suitable. The body 12 has a generally elongated cylindrical shape that defines an axial direction A generally along or parallel to a center axis of the shape, a radial direction B generally perpendicular to the center axis, and a circumferential direction C generally along a circumference of the shape. To receive optional o-rings, several annular grooves 22 can be formed in an outer surface 24 of the body 12. When used, the o-rings help seal the interfaces between the body 12 and the power steering fluid pump and banjo 20.

Still referring to FIGS. 1 and 2, the body 12 has a first end 26 which may have a first opening 28, and has a second end 30 which may have a second opening 32. In installation in this embodiment, the first end 26 is inserted into and communicates with the power steering fluid pump. The body 12 also has one or more inlet passages 34 and one or more outlet passages 36. The inlet passages 34 communicate directly with the power steering fluid pump and receive pressurized fluid therefrom. The outlet passages 36, on the other hand, communicate with the banjo 20 and direct exiting fluid-flow thereto. In other embodiments, the inlet passage could be a single passage and, likewise, the outlet passage could be a single passage. Referring particularly to FIG. 2, a primary passage 38 extends axially through the body 12 and between the first and second openings 28, 32. The primary passage 38 also communicates the inlet passages 34 with the outlet passages 36 for fluid-flow therebetween during use of the power steering fluid pump valve 10. Along its axial extent, the primary passage 38 has diametrically-reduced and diametrically-expanded sections. In this embodiment, the inlet and outlet passages 34, 36 are oriented radially and perpendicularly with respect to the primary passage 38. In other embodiments, the exact design and orientation of the passages with respect to one another may be dependent upon the application, the power steering fluid pump, and other components of the power steering system. Furthermore, an opening 40 is shown in the body 12 of FIGS. 1 and 2 and is used in a particular fluid pump application to cooperate with the fluid pump. Again, as with other components, the opening 40 is optional and need not be provided in all embodiments. In one example, from first opening 28 to second opening 32, the body 12 has an overall axial length of approximately 2.788 inches; of course other lengths are possible in other examples.

As previously noted, the power steering fluid pump valve 10 can be manually adjusted by the user to change the volumetric flow rate of fluid exiting the valve and traveling to downstream components of the power steering system. In this embodiment, the body 12 includes a part of an adjustment feature 42 that enables this functionality. Referring now to FIGS. 3-5, the adjustment feature 42 is in the form of a plurality of notches located in the body 12: a first notch 44, a second notch 46, a third notch 48, a fourth notch 50, a fifth notch 52, and a sixth notch 54. The term notches, as used herein, broadly describes recesses, openings, slots, and other voids that can have open and closed ends on any of its sides. The notches are located near the second end 30, and are circumferentially spaced apart from one another around the body 12. FIG. 3 shows the second end 30 rotated one-hundred-and-eighty degrees from its circumferential orientation shown in FIG. 1 (hence, the notches are not shown in FIG. 1). Here, the notches are separated from one another via notch walls 56. Each notch has an open end 58 and a closed end 60, and each notch is oriented with its open end directed axially with respect to the generally cylindrical shape of the body 12. Each notch also defines an axial dimension, or depth, measured between the open end 58 and the closed end 60, and the axial dimension of each notch has a different value with respect to one another. In one example, the axial dimension values gradually increase from the first notch 44 and to the sixth notch 54, and have respective values of 0.0625 inches (first notch), 0.0735 inches (second notch), 0.0845 inches (third notch), 0.0955 inches (fourth notch), 0.1085 inches (fifth notch), and 0.1295 inches (sixth notch); of course, other depths are possible in other examples.

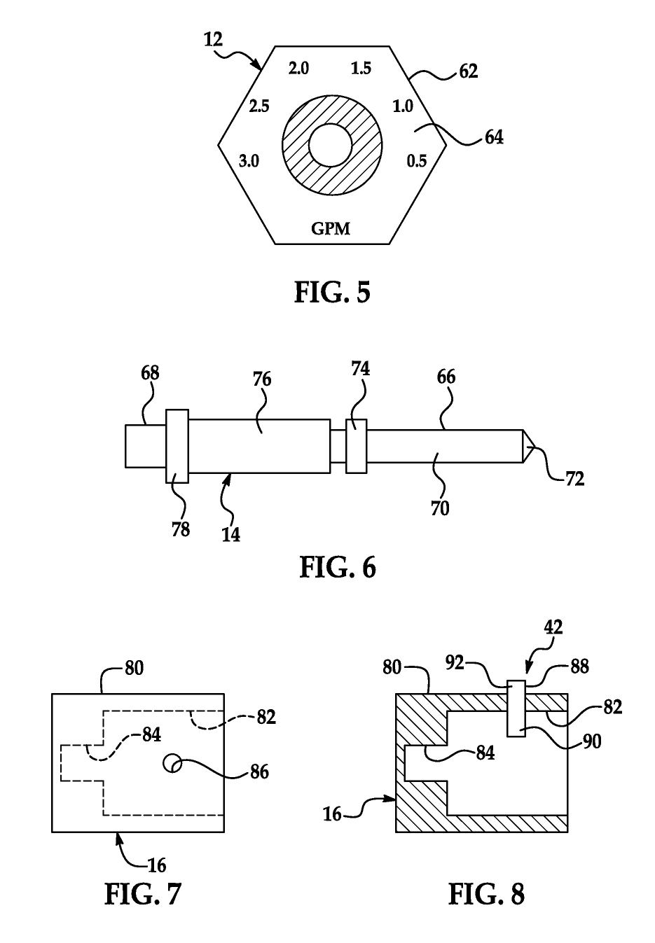

As will be described in greater detail below, another part of the adjustment feature 42 is inserted into a single notch for a desired setting. And each setting brings the metering plunger 14 to a different axial position inside of the primary passage 38 and inside of the calibration fitting 18. Further, the body 12 can have a diametrically-enlarged flange 62 that can aid assembly of the banjo 20 onto the body, can aid seating of the body to the power steering fluid pump housing, or can do both. In other embodiments, the flange 62 need not be provided, or need not be diametrically-enlarged; as with other designs and constructions, this may be application specific. Referring in particular to FIG. 5, the flange 62 can have a face 64 exposed to the user and with visible indicia denoting the corresponding volumetric flow rate value for the selected notch and setting of the adjustment feature 42. In this embodiment, the first notch 44 corresponds to a 0.5 GPM volumetric flow rate value, the second notch 46 corresponds to a 1.0 GPM volumetric flow rate value, the third notch 48 corresponds to a 1.5 GPM volumetric flow rate value, the fourth notch 50 corresponds to a 2.0 GPM volumetric flow rate value, the fifth notch 52 corresponds to a 2.5 GPM volumetric flow rate value, and the sixth notch 54 corresponds to a 3.0 GPM volumetric flow rate value. The different settings are thus offset by 0.5 GPM increments; of course, other values and other increments are possible in other embodiments. Furthermore, an optional cutout 65 is shown in FIGS. 1 and 4, and can be used to accommodate initial assembly of the knob 16 onto the body 12.

The metering plunger 14 interacts with the calibration fitting 18 and with the primary passage 38 of the body 12 to change the volumetric flow rate of power steering fluid-flow through the valve 10. The metering plunger 14 can have different designs and constructions depending in part upon the application, the power steering fluid pump, other components of the power steering system, and the body 12. Referring to FIG. 6, in this embodiment in assembly the metering plunger 14 is located partly within the calibration fitting 18 and partly within the primary passage 38 to physically restrict fluid-flow therethrough. The metering plunger 14 has a generally cylindrical shape and is made out of a suitable steel material; other shapes are possible and other materials such as other metals or composites are suitable. The metering plunger 14 can have a stem 66 and a head 68. The stem 66 has an insertion portion 70 with a diameter sized for receipt within the slightly larger diameter of the primary passage 38 and within the slightly larger diameter of the calibration fitting 18, providing a gap or clearance between them. In use, power steering fluid flows in the clearance as it makes its way through the valve 10. A somewhat pointed or tapered free end 72 facilitates fluid-flow as fluid initially encounters the stem 66 and continues through the clearance. The stem 66 can also have various diametrically-enlarged portions 74, 76, 78 that serve to fit the metering plunger 14 with the body 12. As previously noted, different bodies may require different metering plungers for this purpose. In this embodiment, the head 68 is used for a press-fit connection with the knob 16. In one example, from end-to-end, the metering plunger 14 has an overall axial length of approximately 1.955 inches; of course, other lengths are possible in other examples.

The knob 16 serves as an actuator for the user to manually set the power steering fluid pump valve 10 in different settings and to the desired volumetric flow rate value. The knob 16 can have different designs and constructions depending in part upon the application, the power steering fluid pump, other components of the power steering system, and the metering plunger 14. Referring to FIGS. 7-9, in this embodiment the knob 16 is press-fit onto the head 68 of the metering plunger 14; other ways of connecting the knob and the metering plunger together are suitable. The knob 16 is made out of a 7075 aluminum alloy material, but other materials such as other metals or composites are suitable. An outer surface 80 can be provided with knurls for gripping by the user. To receive press-fit insertion of the head 68 of the metering plunger 14, the knob 16 can have a hollowed interior with a first cavity 82 and a comparatively smaller second cavity 84. A hole 86 extends radially between the outer surface 80 and the first cavity 82, and is sized to receive press-fit of a dowel pin 88. The term pin, as used herein, broadly describes nubs, extensions, and other projections that engage and mate with the notches. The dowel pin 88 can be inserted and press-fit into the hole 86 and has a free end portion 90 protruding and suspended inside of the first cavity 82.

The dowel pin 88 constitutes another part of the adjustment feature 42 that enables changing of the volumetric flow rate of fluid-flow exiting the power steering fluid pump valve 10. Particularly, interaction between the dowel pin 88 and the notches 44, 46, 48, 50, 52, 54 maintains the valve 10 in its different flow rate settings. For example, the dowel pin 88 can be inserted into the third notch 48 to put the valve 10 in the 1.5 GPM volumetric flow rate setting. That is, the free end portion 90 is abuttingly received and slid into the third notch 48 until it makes contact with the closed end 60 of the third notch. Another free end portion 92 of the dowel pin 88 angularly aligns with the respective indicium on the flange 62 that denotes the selected flow rate value. This way, the user can visibly observe the selected setting corresponding to the knob's circumferential position. When initially assembled, the dowel pin 88 can slide through the cutout 65.

The spring 17 is used to bias the dowel pin 88 in the selected notch 44, 46, 48, 50, 52, 54, and therefore help maintain the desired flow rate setting of the power steering fluid pump valve 10 during use. Referring to FIG. 17, the spring 17 can be a compression coil spring, and can be inserted over the stem 66 and within the first cavity 82 of the knob 16. In assembly, the spring 17 can bear against a confronting interior surface of the first cavity 82 and, oppositely, can bear against a confronting exterior surface of the body 12 near the second end 30. The knob 16 and the metering plunger 14 are therefore biased away from the body 12 in the axial direction A, and the dowel pin 88 is biased against the closed end 60 of the respective notch and temporarily secured therein. In other embodiments, other types of springs are possible that bias the dowel pin 88 and the respective notch toward each other.

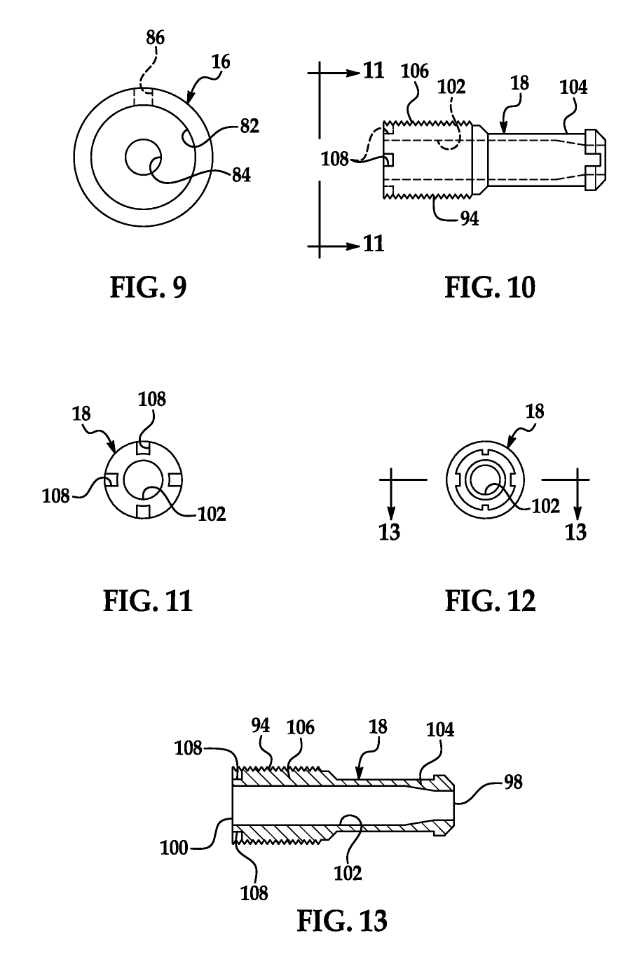

The calibration fitting 18 is set in the primary passage 38 of the body 12 to calibrate and maintain a desired volumetric flow rate value of power steering fluid flow through the valve 10. The calibration fitting 18 can have different designs and constructions depending in part upon the application, the power steering fluid pump, other components of the power steering system, and the body 12. Referring to FIGS. 9-13, in this embodiment the calibration fitting 18 has outer threads 94 that are mated with inner threads 96 of the body 12 near the first end 26 upon calibration. To provide a permanent attachment between the two after calibration, for example, a staking process can be used to stake the fitting 18 and the body 12 together. The calibration fitting 18 is made out of a suitable steel material, but other materials such as other metals or composites are suitable. Like the body 12, the calibration fitting 18 has a generally elongated cylindrical shape with a first opening 98 and a second opening 100. A passage 102 extends axially through the calibration fitting 18 and between the first and second opening 98, 100.

In assembly, the second opening 100 is located adjacent to, and communicates with, the inlet passages 34 of the body 12. Near the first opening 98, the calibration fitting 18 has a reception portion 104 that telescopically receives the stem 66 of the metering plunger 14 within the passage 102. And near the second opening 100, the calibration fitting 18 has a threaded portion 106 with the outer threads 94 and with a relief 108 for receiving a tool during calibration. To initially calibrate volumetric flow rate exiting the valve 10, the calibration fitting 18 can be threaded into the primary passage 38 of the body 12. Threading the calibration fitting 18 deeper into the body 12 increases the telescopic axial overlap distance between the fitting and the stem 66 which therefore increasingly restricts fluid-flow via the defined clearance and decreases volumetric flow rate. Conversely, threading the calibration fitting 18 out of the body 12 reduces the telescopic axial overlap distance between the fitting and the stem 66 which therefore restricts less fluid-flow and increases the volumetric flow rate. The adjustment feature 42 can be set to the first notch 44 which, in this example, corresponds to a 0.5 GPM value. The calibration fitting 18 can then be threaded in and out of the primary passage 38 until 0.5 GPM is measured exiting the outlet passages 36 in order to initially calibrate volumetric flow rate.

The banjo 20 communicates with the outlet passages 36 and receives fluid-flow therefrom, and the banjo connects to the hose of the power steering system. The banjo 20 can have different designs and constructions depending in part upon the application, the power steering fluid pump, other components of the power steering system, and the body 12. Referring to FIGS. 14-16, in this embodiment the banjo 20 is placed around the outside of the body 12 and is located axially at the outlet passages 36. The banjo 20 is made out of a 7075 aluminum alloy material, but other materials such as other steels are suitable. In this embodiment, the banjo 20 has an annular portion 110 defining a through-hole 112, and has a nipple portion 114. The through-hole 112 receives the body 12 upon assembly. The annular portion 110 has a channel 116 on its interior surface that communicates directly with the outlet passages 36, and the nipple portion 114 has a passage 118 extending through it for communication with the channel. The nipple portion 114 can be connected to the hose of the power steering system, as the hose can be fitted over the nipple portion.

To assemble the components of the power steering fluid pump valve 10 together, the metering plunger 14 is press-fit into the knob 16 and the spring 17 is placed around the stem 66. The stem 66 can then be inserted into the primary passage 38 of the body 12 and the adjustment feature 42 can be put in one of the settings to keep the metering plunger 14, knob 16, and spring 17 in place. Further, the calibration fitting 18 can be threaded into the opposite side of the primary passage 38, or could be pre-set therein and already calibrated. The banjo 20 can be placed around the outside of the body 12 and connected to the hose.

In use, in a first setting of the adjustment feature 42, the dowel pin 88 is inserted and retained via the spring 17 into the first notch 44, and fluid-flow exits the power steering fluid pump valve 10 at approximately 0.5 GPM. Here, the stem 66 of the metering plunger 14 is located within the passage 102 of the calibration fitting 18 at its greatest forward axial position. To subsequently adjust to a sixth setting of the adjustment feature 42, for example, the knob 16 is pushed axially forward against the spring's bias to move the dowel pin 88 out of the first notch 44, and the knob is then turned and rotated about its center axis to the angular and circumferential position of the sixth notch 54. The knob 16 can be released and the dowel pin 88 is inserted and retained via the spring 17 rearwardly into the sixth notch 54. In this setting, the stem 66 of the metering plunger 14 is located within the passage 102 of the calibration fitting 18 at its greatest rearward axial position and fluid-flow exits the power steering fluid pump valve 10 at approximately 3.0 GPM.

The power steering fluid pump valve can have different designs and constructions than those shown in the figures and described above. For example, the power steering fluid pump valve need not have all of the components shown in the figures and instead could include only the body and the metering plunger; in this example, the head of the metering plunger could function as the knob, or the knob and the metering plunger could be formed unitarily as one-piece. In another example, the adjustment feature could include the notches in the knob and the dowel pin could extend from the body. In yet another example, the notches of the adjustment feature could be arranged linearly along the axis of the body instead of around its circumference; in this example, the knob would be moved axially to initially change settings instead of rotationally, but then would be moved rotationally for insertion between pin and notches or other complementary structures. In another example, the pin and notches could be other complementary structures that engage and mate with each other for setting the adjustment feature. And in another example, there could be more or less numbers of notches and settings.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A power steering fluid pump valve, comprising:
a body having an inlet, an outlet, and a passage extending between said inlet and said outlet for power steering fluid-flow therethrough; and
a metering plunger having a stem at least partly located in said passage, wherein said metering plunger is adjusted to bring said stem to different forward and rearward axial positions within said passage in order to change the volumetric flow rate of power steering fluid-flow through said outlet.

2. The power steering fluid pump valve of claim 1, wherein one of said body or said metering plunger has a plurality of notches and the other of said body or said metering plunger has a pin, each notch corresponding to an axial position of said stem within said passage and to a volumetric flow rate value through said outlet, said pin being inserted into one of said plurality of notches to bring said stem to the respective axial position and to the respective volumetric flow rate value.

3. The power steering fluid pump valve of claim 2, wherein each of said plurality of notches has a different depth dimension with respect to the other of said plurality of notches, and each depth dimension corresponding to a position of said stem within said passage and to a volumetric flow rate value through said outlet.

4. The power steering fluid pump valve of claim 2, wherein each of said plurality of notches has a different circumferential position with respect to the other of said plurality of notches.

5. The power steering fluid pump valve of claim 1, wherein said body has a plurality of notches, each notch corresponding to an axial position of said stem within said passage and to a volumetric flow rate value through said outlet, and said metering plunger has a pin that is inserted into one of said plurality of notches to bring said stem to the respective axial position and to the respective volumetric flow rate value.

6. The power steering fluid pump valve of claim 1, wherein said metering plunger is turned about its center axis to bring said stem to different forward and rearward axial positions within said passage in order to change the volumetric flow rate of power steering fluid-flow through said outlet.

7. The power steering fluid pump valve of claim 1, further comprising a knob extending from said metering plunger and used to bring said metering plunger to different forward and rearward axial positions.

8. The power steering fluid pump valve of claim 1, further comprising a spring biasing said metering plunger and said stem to the adjusted axial position.

9. The power steering fluid pump valve of claim 1, further comprising a calibration fitting set in said passage of said body in order to calibrate the volumetric flow rate of power steering fluid-flow through said outlet.

10. The power steering fluid pump valve of claim 1, further comprising a banjo located around said body at said outlet to receive power steering fluid-flow exiting said outlet.

11. A power steering fluid pump valve, comprising:
a body having an inlet, an outlet, and a passage extending between said inlet and said outlet for power steering fluid-flow therethrough;
a metering plunger at least partly located in said passage; and
an adjustment feature releasably retaining said metering plunger relative to said body in at least two positions, wherein each position corresponds to a different location of said metering plunger in said passage and corresponds to a different volumetric flow rate of power steering fluid-flow out of said outlet.

12. The power steering fluid pump valve of claim 11, wherein said adjustment feature includes a plurality of notches and a pin, each notch corresponding to a different location of said metering plunger in said passage and to a different volumetric flow rate of power steering fluid-flow out of said outlet, said pin being inserted into one of said plurality of notches to retain said metering plunger relative to said body in the respective location and volumetric flow rate valve.

13. The power steering fluid pump valve of claim 12, wherein said plurality of notches are located in said body, and further comprising a knob extending from said metering plunger, and said pin extending from said knob.

14. The power steering fluid pump valve of claim 12, wherein said body has a surface with indicia denoting the different volumetric flow rates of power steering fluid-flow out of said outlet, and said pin lines-up with said indicia when said pin is inserted into one of said plurality of notches in order to indicate to the user the respective volumetric flow rate value.

15. The power steering fluid pump valve of claim 12, wherein said adjustment feature also includes a spring biasing said pin and the respective one of said plurality of notches together, and, in order to adjust said adjustment feature and insert said pin into a different one of said plurality of notches, said metering plunger is moved against the bias of said spring.

16. The power steering fluid pump valve of claim 11, wherein, in order to adjust said adjustment feature and bring said metering plunger relative to said body in said at least two positions, said metering plunger is moved axially relative to said body and is moved circumferentially relative to said body.

17. The power steering fluid pump valve of claim 11, further comprising a calibration fitting set in said passage of said body in order to calibrate the volumetric flow rate of power steering fluid-flow out of said outlet.

18. The power steering fluid pump valve of claim 17, further comprising a banjo located around said body at said outlet to receive power steering fluid-flow out of said outlet.

19. A power steering fluid pump valve, comprising:
a body having an inlet, an outlet, and a passage extending between said inlet and said outlet for power steering fluid-flow therethrough;
a metering plunger having a portion at least partly located in said passage;
a plurality of notches located in said body or in said metering plunger, each of said plurality of notches corresponding to a position of said portion within said passage and to a volumetric flow rate of power steering fluid-flow through said outlet;
a pin extending from the other of said body or said metering plunger without said plurality of notches, said pin constructed for insertion into one of said plurality of notches; and
a spring biasing said pin and the respective one of said plurality of notches together;
wherein, to move said pin from one of said plurality of notches to another one of said plurality of notches, said metering plunger is moved against the bias of said spring and is moved circumferentially relative to said body, moved axially relative to said body, or both.

20. The power steering fluid pump valve of claim 19, further comprising;
a knob extending from said metering plunger and used to move said metering plunger against the bias of said spring;
a calibration fitting set in said passage of said body in order to calibrate the volumetric flow rate of power steering fluid-flow through said outlet; and
a banjo located around said body at said outlet to receive power steering fluid-flow through said outlet.
